(19) United States
(12) Patent Application Publication
(10) Pub. No.: US 2024/0199160 A1
(43) Pub. Date: Jun. 20, 2024

(54) Tilting Vehicle With a Luggage Fastening Device

(71) Applicant: Bayerische Motoren Werke Aktiengesellschaft, Muenchen (DE)

(72) Inventor: Jean-Thomas MAYER, Muenchen (DE)

(21) Appl. No.: 18/287,211

(22) PCT Filed: Mar. 1, 2022
(86) PCT No.: PCT/EP2022/055028

§ 371 Date: Oct. 17, 2023

(30) Foreign Application Priority Data
Apr. 26, 2021 (DE) 10 2021 110 543.9

(51) Int. Cl. B62J 7/08

(52) U.S. Cl. CPC B62J 7/08

(57) ABSTRACT

A tilting vehicle with a luggage fastening device for fastening a luggage item to the tilting vehicle is provided, wherein the luggage fastening device comprises at least one tensioning element which is configured to engage around the luggage item at least in sections in an operating position, and the at least one tensioning element is connected with a first end to a stowage device and has a free second end which is configured for releasable connection to a holding portion of the tilting vehicle, wherein the stowage device is configured to selectively receive and remove at least one portion of the at least one tensioning element.

### BACKGROUND AND SUMMARY

The invention relates to a tilting vehicle having a luggage fastening device for fastening an item of luggage to the tilting vehicle.

In the case of tilting vehicles, such as motorbikes or motor scooters, a storage space is often very limited. If items of luggage are intended to be carried along, these can be stowed, for example, in saddlebags or top cases, provided these are available in the respective situation and have sufficient storage capacity.

As an alternative, in particular larger and/or flexible items of luggage are often fastened to the vehicle by means of tensioning straps or ropes. Here, however, suitable fastening points on the vehicle have to be located in order to enable secure lashing-down.

In addition, in a non-used state, the tensioning straps or ropes have to be securely stowed in the vehicle, in order to keep them available in case of need. Since this always involves separate fixtures, the tensioning straps or ropes can be easily lost.

An object of the invention is to provide a fastening device for an item of luggage on a tilting vehicle, in order to reduce or avoid at least one of the mentioned disadvantages.

The object is achieved by means of a tilting vehicle having a luggage fastening device according the independent claim. Advantageous embodiments emerge from the patent claims which are dependent thereon.

Accordingly, a tilting vehicle having a luggage fastening device for fastening an item of luggage to the tilting vehicle is provided, wherein the luggage fastening device comprises at least one tensioning element which, in an operating position, is configured to at least partially engage around the item of luggage, and the at least one tensioning element is connected by a first end to a stowage device and has a free second end which is configured for releasable connection to a retaining portion of the tilting vehicle. Moreover, the stowage device is configured for the selective take-up and removal of at least one portion of the at least one tensioning element.

Within the meaning of this description, a tilting vehicle is understood to mean motorbikes or motorcycles in particular, but also motor scooters, for example two-wheeled, three-wheeled or four-wheeled motor scooters or scooters, and also trikes or quad bikes. However, in principle, use in other motor vehicles with a corresponding seat arrangement, such as in snowmobiles, is also possible.

The tilting vehicle thus comprises the luggage fastening device, by means of which it is possible to fasten items of luggage to the vehicle. In this regard, said luggage fastening device comprises the one or more tensioning elements. These are connected by a respective first end to the stowage device and can also be fastened at the second end to the vehicle for fastening of the luggage. Here, the respective tensioning element can be placed over the item of luggage and can apply a load thereto by way of a portion arranged between the first end and the second end and thus tension said item of luggage against the vehicle, in order to hold it in the desired position.

The at least one tensioning element is, as described, connected on one side by the first end to the stowage device. The connection may, for example, be designed in such a way that it forms a fixed and permanent connection. The connection of the first end to the stowage device already affords the advantage that the respective tensioning element can no longer be lost in the non-used state.

In order to stow the respective tensioning element, in particular in the non-used state, in the stowage position and to store it for subsequent use, the stowage device may take up the respective tensioning element entirely or only partially. If the tensioning element is intended to be used, the respective tensioning element can be at least partially removed from the stowage device again.

According to one embodiment of the stowage device, the at least one tensioning element may be removable by being able to pull it out of the stowage device in order to bring the at least one tensioning element from the stowage position into the operating position. This means that the at least one tensioning element can be easily made available when required by pulling it out of the stowage device.

The at least one tensioning element is preferably in the form of a strap or rope.

In addition, the at least one tensioning element may comprise, at the second end, a fastening element, in particular a hook-shaped fastening element, which is configured for releasable connection to the retaining portion. The retaining portion may comprise, for example, an eye or a cutout into which the hook-shaped fastening element can engage. Merely by way of example, the hook-shaped fastening element may be embodied in a self-securing manner, for example in the form of what is known as a snap hook.

Furthermore, the stowage device may be configured for the selective winding up or unwinding of the at least one tensioning element. This offers the possibility of stowing the respective tensioning element in an easy and space-saving manner. In this regard, the stowage device may comprise a winding-up mechanism. This may be in the form, for example, of a rotatable roll or drum onto the outer lateral surface of which the tensioning element can be wound up or from the outer lateral surface of which the tensioning element can be unwound.

According to one embodiment, the winding-up mechanism may be configured to automatically wind up the at least one tensioning element. For example, the winding-up mechanism may additionally comprise a restoring device which actuates the winding-up mechanism when required in order to automatically wind up the at least one tensioning element.

If the winding-up mechanism is by way of example in the form of a roll or drum, the winding-up mechanism may comprise a restoring device in the form of a spring element. The winding-up mechanism may be configured in such a way that the winding-up mechanism or the restoring device is already placed under preload during the unwinding of the tensioning element, preferably owing to the unwinding movement. Subsequently, owing to the preload of the winding-up mechanism the restoring device can bring about the automatic winding-up in a movement in the opposite direction.

As an alternative to a mechanical generation of the preload by means of a spring element, the winding-up mechanism may for example comprise a drive, in particular an electromotive drive, which sets the winding-up mechanism into a corresponding movement as required for the purpose of winding up the at least one tensioning element.

Furthermore, the stowage device may comprise an arresting device which is configured to arrest the at least one tensioning element in a partially or completely unwound state with respect to the stowage device. The arresting device may for example be a self-locking locking device which, in the locked state, prevents further unwinding of the tensioning element. This means that a subsequent continuation of the unwinding of the tensioning element is avoided so as to not unintentionally release a fastening or the tensioning of the item of luggage. The arresting device may for example comprise a mechanical locking element.

The stowage device may also be arranged below a seat. This offers the possibility of positioning the stowage device in the tilting vehicle in an unobtrusive manner and in an optimized manner in terms of installation space. This positioning makes it possible for the at least one tensioning element below the seat to be pulled out of the stowage device when required and for an item of luggage to be fastened to be positioned on the seat and secured thereon.

For example, at least one opening of the stowage device, said at least one opening being provided for the selective take-up and removal of the at least one tensioning element, may be assigned to a first end of the seat and the retaining portion may be assigned to a second end of the seat. Here, the first end and the second end may be provided opposite to one another on the seat. Preferably, the seat is a pillion seat or a rear seat portion of a bench seat. For example, in a longitudinal direction of the seat (in the installed state this longitudinal direction corresponds to a vehicle longitudinal direction of the vehicle), the first end forms a front end of the seat. Correspondingly, the second end which is opposite thereto forms the rear end of the seat.

It goes without saying that an inverse arrangement is equally possible, according to which the rear end of the seat forms the first end and the front end forms the second end.

As an alternative, however, an orientation in a vehicle transverse direction is also possible. In this case, the first end is formed by a lateral, left-hand edge of the seat and the second end is formed by a lateral, right-hand edge of the seat. An inverse arrangement is equally possible, in which the first end is formed by a lateral, right-hand edge of the seat and the second end is formed by a lateral, left-hand edge of the seat.

In each of these cases, this arrangement makes it possible for the item of luggage to be able to be easily positioned on the seat and fastened thereon by virtue of the at least one tensioning element being able to be tensioned over the item of luggage and releasably connected to the retaining portion.

As an alternative to an arrangement of the stowage device below a seat, an arrangement on a vehicle side or in the region of a vehicle tank or in the region of a front wheel or at another suitable location of the tilting vehicle is, however, also possible, in order to fasten the item of luggage at these locations by means of a luggage fastening device according to this description which is arranged at said locations.

The invention will be explained in more detail below on the basis of an exemplary embodiment with reference to the drawings.

### BRIEF DESCRIPTION OF THE DRAWINGS

FIG. 1 is a perspective view of a rear vehicle part of a tilting vehicle having a luggage fastening device according to the description;

FIG. 2 is a perspective view of the luggage fastening device according to FIG. 1; and

FIG. 3 is a perspective view of the rear vehicle part according to FIG. 1 in a loaded state.

### DETAILED DESCRIPTION OF THE DRAWINGS

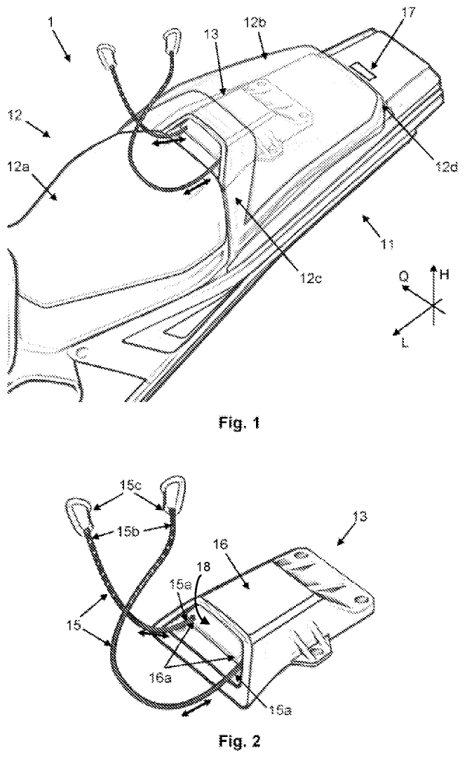

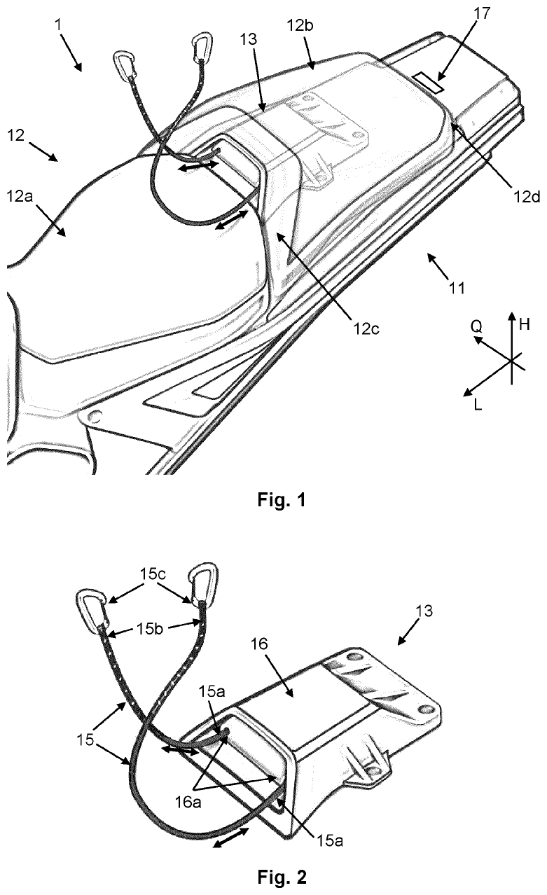

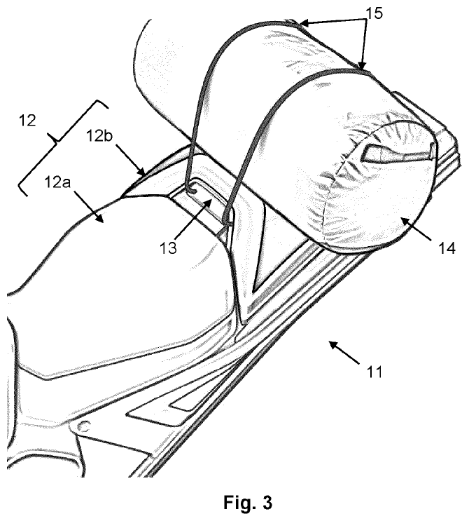

FIG. 1 shows a perspective view of a rear vehicle part 11 of a tilting vehicle 1 having a two-part bench seat 12. This bench seat comprises a rider's seat 12a and a pillion seat 12b. Furthermore, a luggage fastening device 13 is provided, which is configured to fasten an item of luggage 14 to the tilting vehicle 1. A loaded state with the item of luggage 14 arranged on the pillion seat 12b is illustrated in FIG. 3. FIG. 2 shows a detail view of the corresponding luggage fastening device 13.

According to the illustration in FIGS. 1 to 3, the luggage fastening device 13 comprises two tensioning elements 15. In the operating position illustrated in FIG. 3, the tensioning elements are placed over the item of luggage 14 and partially engage around it. The item of luggage 14 is tensioned against the vehicle 1 or against the pillion seat 12b with the aid of the tensioning elements 15 and thus is held there in the desired position.

In this regard, the two tensioning elements 15 are connected by a respective first end 15a to a stowage device 16. The connection of the first end 15a is in the form of a fixed and permanent connection, and therefore the respective tensioning element 15 can no longer be lost in the non-used state. A free second end 15b of the respective tensioning element 15, said second end being arranged opposite the respective first end 15a, is configured for releasable connection to a retaining portion 17 of the tilting vehicle 1.

In addition, the stowage device 16 is configured for the selective take-up and removal of at least one portion of the respective tensioning element 15. In this way, the respective tensioning element 15 can be stowed, in particular in the non-used state, in the stowage position and stored for subsequent use. If the tensioning elements 15 are intended to be used, the respective tensioning element 15 can at least partially be removed from the stowage device 16 again. In this regard, the two tensioning elements 15 are each configured to be able to be pulled out of the stowage device 16 in order to bring the tensioning elements 15 from the stowage position into the operating position when required.

The two tensioning elements 15 are each by way of example in the form of a rope. As an alternative, however, the respective tensioning element 15 may also be designed as a strap.

For the fastening of the second end 15b, each of the two tensioning elements 15 comprises, at the second end 15b, a fastening element 15c for releasable connection to the retaining portion 17. According to the illustrated embodiment, the fastening element 15c is in the form of a hook-shaped fastening element 15c. Merely by way of example, the hook-shaped fastening element 15c is provided in the form what is known as a snap hook, it self-evidently also being possible to use other shapes which enable engagement into the retaining portion 17 or engagement behind the retaining portion 17 for the purpose of generating a releasable connection. The retaining portion 17 may for example comprise an eye or a cutout into which the hook-shaped fastening element 15c can engage.

In addition, the stowage device 16 is configured for the selective winding up or unwinding of the two tensioning elements 15. In this regard, the stowage device 16 comprises a winding-up mechanism 18 for automatically winding up the tensioning elements 15. With the aid of said winding-up mechanism, the two tensioning elements 15 can be pulled out of the stowage device in order to fasten the item of luggage 14. If the tensioning elements 15 are intended to be stowed, these can be wound up again with the aid of the winding-up mechanism and thus stowed on the stowage device or in the interior of the stowage device 16. In the illustrated case, the stowage device 16 forms, in this regard, a corresponding housing for taking up the tensioning elements 15 in an interior space formed in the housing.

In order to avoid further unwinding and thus unintentional releasing of the fastening of the item of luggage 14, the stowage device 16 comprises an arresting device. This is configured to arrest the respective tensioning element 15 in a partially or completely unwound state on or in the stowage device 16. The arresting device may, for example, be a self-locking locking device which, in the locked state, prevents further unwinding of the respective tensioning element 15. This means that a subsequent continuation of the unwinding of the tensioning element 15 is avoided so as to not unintentionally release a fastening of the item of luggage 14.

As is apparent from FIGS. 1 to 3, the stowage device 16 is arranged below a pillion seat 12b. This offers the possibility of positioning the stowage device 16 in the tilting vehicle 1 in an unobtrusive manner and in an optimized manner in terms of installation space. This positioning makes it possible for the two tensioning elements 15 below the pillion seat 12b to be pulled out of the stowage device 16 when required and for the item of luggage 14 to be fastened—as illustrated in FIG. 3—to be positioned on the pillion seat 12b and secured thereon.

As is apparent in the illustrated embodiment, a respective opening 16a of the stowage device 16, said opening being provided for the selective take-up and removal of a respective one of the tensioning elements 15, is assigned to a first end 12c and the retaining portion 17 is assigned to a second end 12d of the pillion seat 12b. Here, the first end 12c and the second end 12d are provided opposite to one another on the pillion seat 12b. According to the illustrated embodiment, the pillion seat 12b is in the form of a separate seat. As an alternative (and therefore not illustrated), the pillion seat 12b may, however, also be in the form of a rear seat portion of a bench seat. In this case, the openings 16a could be positioned between a front seat portion for the rider and the rear seat portion for the pillion passenger.

For example, in a longitudinal direction L of the pillion seat 12b (in the installed state this longitudinal direction corresponds to a vehicle longitudinal direction of the tilting vehicle 1), the first end 12c of the pillion seat 12b forms the front end of the pillion seat 12b. Correspondingly, the second end 12d which is opposite thereto forms the rear end of the pillion seat 12b.

It goes without saying that according to a non-illustrated embodiment an inverse orientation is equally possible, according to which the rear end of the seat forms the first end and the front end forms the second end. However, an orientation in a vehicle transverse direction Q is equally also possible.

In each of these cases, this arrangement makes it possible for the item of luggage 14 to be able to be easily positioned (in a vertical direction H) on the pillion seat 12b and fastened thereon by virtue of the two tensioning elements 15 being able to be tensioned over the item of luggage 14 and releasably connected to the retaining portion 17.

1.-9. (canceled)

10. A tilting vehicle, comprising:
a luggage fastening device for fastening an item of luggage to the tilting vehicle,
wherein the luggage fastening device comprises at least one tensioning element which, in an operating position, is configured to at least partially engage around the item of luggage; and
a stowage device to which a first end of the at least one tensioning element is connected;
a retaining portion of the tilting vehicle, to which a free second end of the tensioning element is configured for releasable connection to the retaining portion, and
the stowage device is configured for selective take-up and removal of at least one portion of the at least one tensioning element.

11. The tilting vehicle according to claim 10, wherein
the at least one tensioning element is configured to be able to be pulled out of the stowage device in order to bring the at least one tensioning element from the stowage position into the operating position.

12. The tilting vehicle according to claim 10, wherein the at least one tensioning element is a strap or rope.

13. The tilting vehicle according to claim 10, wherein
the at least one tensioning element comprises, at the free second end, a fastening element configured for a releasable connection to the retaining portion.

14. The tilting vehicle according to claim 13, wherein
the fastening element is a hook-shaped fastening element.

15. The tilting vehicle according to claim 10, wherein
the stowage device is configured for the selective winding up or unwinding of the at least one tensioning element.

16. The tilting vehicle according to claim 15, wherein
the stowage device comprises a winder for automatically winding up the at least one tensioning element.

17. The tilting vehicle according to claim 16, wherein
the stowage device comprises an arrester configured to arrest the at least one tensioning element in a partially or completely unwound state with respect to the stowage device.

18. The tilting vehicle according to claim 10, wherein the stowage device is arranged below a seat.

19. The tilting vehicle according to claim 18, wherein
at least one opening of the stowage device is assigned to a first end of the seat and the retaining portion is assigned to a second end of the seat,
the at least one opening is provided for the selective take-up and removal of the at least one tensioning element.
